(19) United States
(12) Patent Application Publication
(10) Pub. No.: US 2025/0204544 A1
(43) Pub. Date: Jun. 26, 2025

(54) OCTENYLSUCCINYLATED WAXY TAPIOCA STARCHES, EMULSIONS INCLUDING THEM AND METHODS FOR MAKING SAME

(71) Applicant: TATE & LYLE SOLUTIONS USA LLC, Hoffman Estates, IL (US)

(72) Inventors: James T. Smoot, Hoffman Estates, IL (US); Ehsan Jenab, Hoffman Estates, IL (US); Ying Xie, Hoffman Estates, IL (US)

(21) Appl. No.: 18/852,060

(22) PCT Filed: Mar. 30, 2023
(86) PCT No.: PCT/US2023/016886

§ 371 Date: Sep. 27, 2024

Related U.S. Application Data
(60) Provisional application No. 63/325,871, filed on Mar. 31, 2022.

(51) Int. Cl. A23D 7/005; A23D 7/04; A23L 27/00; A23L 29/10; C08B 31/04

(52) U.S. Cl. CPC A23D 7/0053; A23D 7/04; A23L 27/80; A23L 29/10; C08B 31/04

(57) ABSTRACT

The present disclosure relates generally to starch products. More particularly, the present disclosure relates to octenylsuccinylated-modified non-inhibited waxy tapioca starches, emulsions including them, food products including such emulsions, and methods for making all such compositions. In one aspect, the disclosure provides a waxy tapioca starch having an amylopectin content in the range of 90-100%; and a degree of octenylsuccinyiation of at least 1.0 wt % on a dry solids basis, wherein the starch is not inhibited. The starch can be provided in pregelatinized form. Other aspects of the disclosure include emulsions stabilized by such starches and foods, beverages, personal care compositions, nutraceutical compositions and pharmaceutical compositions including them.

### BACKGROUND OF THE DISCLOSURE

### Field of the Disclosure

The present disclosure relates generally to starch products. More particularly, the present disclosure relates to octenylsuccinylate-modified non-inhibited waxy tapioca starches, emulsions including them, food products including such emulsions, and methods for making all such compositions.

### Technical Background

Higher molecular weight cooked starch emulsifiers on the market, such as those used in salad dressings, can tend to form gels through retrogradation when they are used in various food systems. Such gel formation is undesirable as it can cause changes in food organoleptic properties, loss of emulsion stability, and generally result in short shelf life of food products. These gels are especially problematic in formulations that require cold storage.

One conventional way to provide a starch emulsifier is to modify a corn starch with octenylsuccinic anhydride, which provides octenylsuccinylate groups pendant on the starch. This provides some protection against retrogradation, but the starch is nonetheless susceptible to formation of a gel under refrigeration conditions. This is true even when waxy corn starch is used; while it does not contain amylose, which retrogrades rapidly and forms hard gels, the amylopectin can slowly reassociate to form a gel. And this is a common problem with emulsions based on octenylsuccinylated waxy corn starch.

There remains a need for cold-stable emulsifying starch products.

### SUMMARY OF THE DISCLOSURE

One aspect of the disclosure is a waxy tapioca starch having
an amylopectin content in the range of 90-100%; and
a degree of octenylsuccinylation of at least 1.0 wt % on a dry solids basis,
   wherein
the starch is not inhibited, and
the starch is pregelatinized.

Another aspect of the disclosure is a waxy tapioca starch having
an amylopectin content in the range of 90-100%; and
a degree of octenylsuccinylation of at least 1.0 wt % on a dry solids basis,
   wherein
the starch is not inhibited.

Another aspect of the disclosure is an emulsion comprising an emulsified phase that is a hydrophobic phase emulsified with an aqueous phase, stabilized by a gelatinized starch that is the gelatinized product of a waxy tapioca starch having an amylopectin content in the range of 90-100%; and a degree of octenylsuccinylation in an amount of at least 1.0 wt % on a dry solids basis, wherein the starch is not inhibited.

Another aspect of the disclosure is a method for making an emulsion comprising mixing a hydrophobic phase, an aqueous phase and a waxy tapioca starch as described herein under conditions sufficient to form the emulsion (e.g., under shear).

Another aspect of the disclosure is a food, beverage, personal care composition, nutraceutical composition or pharmaceutical composition including an emulsion as described herein.

Other aspects of the disclosure will be apparent in view of the present disclosure.

### BRIEF DESCRIPTION OF THE DRAWINGS

FIG. 1 is a set of micrographs of waxy tapioca starch and waxy corn starch

FIG. 2 is an RVA curve for a thinned waxy tapioca starch of the disclosure as compared to a comparative waxy corn starch and a comparative non-waxy tapioca starch.

FIG. 3 is an RVA curve for a waxy tapioca starch of the disclosure as compared to a comparative waxy corn starch and a comparative non-waxy tapioca starch.

FIG. 4 is a plot of droplet size distribution for emulsions made with a waxy tapioca starch of the disclosure and with a comparative waxy corn starch.

FIG. 5 is a photograph of emulsions made with a waxy tapioca starch of the disclosure and with a comparative waxy corn starch after storage under refrigeration.

FIG. 6 is a light microscopy image of a non-gelatinized waxy tapioca starch of the present disclosure, a pregelatinized waxy tapioca starch of the present disclosure, a comparative non-gelatinized waxy corn starch, and a comparative pregelatinized waxy corn starch.

FIG. 7 is a photograph of a waxy tapioca starch of the disclosure and a comparative waxy corn starch, before and after freeze-thaw treatment.

FIG. 8 is a microscope image of emulsions made without an emulsified starch, an emulsion with a waxy tapioca starch of the disclosure, and a comparative emulsion with a waxy corn starch.

### DETAILED DESCRIPTION

As noted above, emulsions based on non-inhibited octenylsuccinylated waxy corn starches as emulsifiers suffer from poor cold stability as a result of amylopectin retrogradation over time, resulting in the formation of set gels. This is especially problematic in refrigerated food and beverage products, like salad dressings. The present inventors have determined that non-inhibited octenylsuccinylated waxy tapioca starches are as effective as emulsifiers as non-inhibited waxy corn starches, but, unexpectedly, are much more cold stable.

Accordingly, one aspect of the disclosure is a waxy tapioca starch having an amylopectin content in the range of 90-100%; and a degree of octenylsuccinylation of at least 1.0 wt % on a dry solids basis, wherein the starch is not inhibited, and the starch is pregelatinized. As described herein, such a product can be used to form emulsions without cooking.

In this aspect of the disclosure, the waxy tapioca starch is pregelatinized. As the person of ordinary skill in the art will appreciate, the pregelatinization is essentially a pre-cooking starch process that disorganizes the semicrystalline structure of the native starch granule, such that it does not later need to be processed at high temperatures to provide viscosity to a food. As used herein, a “pregelatinized” starch has no more than 25% of its granules exhibiting birefringence, i.e., a high-extinction, so-called “Maltese cross” through the granule when viewed by polarization microscopy. For example, in certain embodiments, no more than 10%, no more than 5%, or even no more than 2% of the granules of the pregelatinized starch exhibit birefringence. As the person of ordinary skill in the art would appreciate, there are many ways to cook a starch to pregelatinize it, e.g., jet cooking, drum drying, and spray cooking (optionally in conjunction with agglomeration). The waxy tapioca starch can be pregelatinized after the octenylsuccinylation, or a pregelatinized waxy tapioca starch can be used in as a feed for octenylsuccinylation.

Another aspect of the disclosure is a waxy tapioca starch having an amylopectin content in the range of 90-100%; and a degree of octenylsuccinylation of at least 1.0 wt % on a dry solids basis, wherein the starch is not inhibited. Such a starch can, in some embodiments, be non-gelatinized. As described herein, such a non-gelatinized starch product can be used in making an emulsion in a process that involves cooking the starch to gelatinize it.

The starches of the disclosure are waxy tapioca starches. The person of ordinary skill in the art will appreciate that various native starches have different relative amounts of the two major components of starch polysaccharides, amylose (a linear, alpha-1,4-linked polyglucoside) and amylopectin (a branched alpha-1,4-linked polyglucoside with alpha-1,6-linked branch points). So-called “waxy” starches (as the term is used herein) have at least 90 wt % amylopectin (i.e., of the total amount of amylose and amylopectin). In various embodiments, a waxy tapioca starch as otherwise described herein has an amylopectin content in the range of 95-100 wt %. In various embodiments, a waxy tapioca starch as otherwise described herein has an amylopectin content of at least 99 wt %, or even at least 99.9 wt %. The high degree of amylopectin provides waxy starches with different properties than non-waxy starches, e.g., higher viscosity and formation of longer and more cohesive pastes.

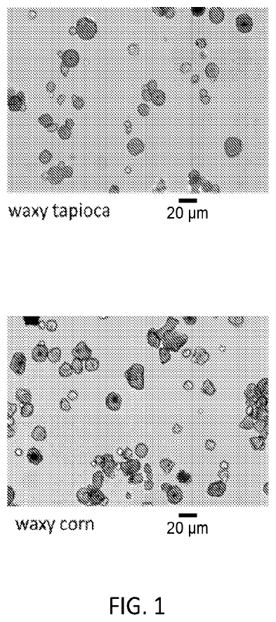

The person of ordinary skill in the art will be able to distinguish waxy tapioca starches from starches from different plant sources, for example, via microscopy and comparison with standards. The person of ordinary skill in the art can, for example, view the starch materials under a microscope, optionally with dying with iodide, and use the size and the shape of the observed granules to determine the type of starch. For example, micrographs of waxy corn starch and waxy tapioca starch are provided in FIG. 1. As shown in the figure, waxy corn starch granules have generally polygonal shapes, while waxy tapioca starch granules are much more round in shape. Staining can be used to distinguish waxy tapioca starch from non-waxy tapioca starch, with the waxy material being brown in color after staining with iodine, and the non-waxy material being blue. As the person of ordinary skill in the art will appreciate, different types of starches from different sources can have different textures and rheological properties, and thus can be desirable for use in different food applications.

The present inventors have noted a difference in branch chain length distributions between octenylsuccinylated waxy tapioca starches and octenylsuccinylated waxy corn starches. As the person of ordinary skill in the art will appreciate, amylopectin has a comb-like structure, in which shorter branch chains are connected to a longer main chain. The present inventors have noted that the distribution of lengths of these branch chains can have a stark effect on performance. Without being bound by theory, the present inventor's hypothesize that this difference in branch chain length distribution may contribute to the improved cold-storage stability observed in the waxy tapioca starches of the disclosure. In various embodiments, a waxy tapioca starch as otherwise described herein has a branch chain branch chain length ratio (DP6-12)/(DP13-24) of at least 0.470, e.g., at least 0.475, wherein DP6-12 is a distribution of short-length branches having a chain length from 6-12 and DP13-24 is a distribution of short-length branches having a chain length from 13-24.

To measure branch chain length distribution, a sample is debranched with isoamylase (i.e., to break the 1,6-alpha glucosyl bonds connecting the branch chains to the 1,4-alpha bonded main chain), then the debranched sample is analyzed by chromatography. A waxy tapioca starch sample (20 mg, dry basis) is mixed with 10 ml of acetate buffer (0.01 M, pH 4) and subsequently cooked in a boiling water bath for 1 hr. After cooling to 50° C., gelatinized starch is debranched with an addition of 20 μL of isoamylase (Megazyme, Wicklow, Ireland). The starch debranching is allowed to proceed overnight (≥12 hr), after which the enzyme is inactivated by heating the sample in a boiling water bath for 30 min. After cooling to room temperature. 1-1.5 mL of sample is passed through a 45 μm filter prior to injection into an AS-DV autosampler of HPAEC (Dionex ICS-3000, Dionex Corp., Sunnyvale, CA) equipped with a pulsed amperometric detector and a CarboPac™ PA1 analytical column. The sample is eluted with a gradient program of 40% of eluent B at 0 min, 50% at 2 min. 60% at 10 min, and 80% at 40 min, in which eluent A is 100 mM aqueous sodium hydroxide and eluent B is 150 mM aqueous sodium hydroxide containing 500 mM sodium acetate. The flow rate and the separation temperature are maintained throughout the measurement at 1 mL/min and 25° C., respectively. Peaks are integrated according to the baseline automatically created by Chromeleon™ version 6.8 (Thermo Fisher Scientific, Waltham, MA). The relative area % of each detectable DP, which refers to the area of each peak in the chromatogram as a percentage of the total area of all peaks, is computed by Chromeleon™. DP2, DP3 and DP6 are confirmed with a 50 ppm maltose, maltotriose, and maltohexaose composite standard. “DP” stands for degree of polymerization, and “DPX” indicates a chain having a length of X dextrose residues. HPLC peak areas are combined as follows: DP1-5; DP6-12; DP13-24; DP25-36; and DP37+, each quantified as a percentage of the total peak area.

In various embodiments, a waxy tapioca starch as otherwise described herein has a branch chain branch chain length ratio (DP6-12)/(DP13-24) of at least 0.480, e.g., at least 0.485. In various embodiments, a waxy tapioca starch as otherwise described herein has a branch chain branch chain length ratio (DP6-12)/(DP13-24) of at least 0.490, e.g., at least 0.495. In various embodiments, a waxy tapioca starch as otherwise described herein has a branch chain branch chain length ratio (DP6-12)/(DP13-24) of at least 0.500, e.g., at least 0.485. For example, in various embodiments, the amylopectin fraction of the waxy tapioca starch has a branch chain length ratio (DP6-12)/(DP13-24) in the range of 0.470-0.540, e.g., 0.475-0.540, or 0.480-0.540, or 0.485-0.540, 0.490-0.540, or 0.495-0.540, or 0.470-0.530, or 0.475-0.530, or 0.480-0.530, or 0.485-0.530, 0.490-0.530, or 0.495-0.530, or 0.470-0.520, or 0.475-0.520, or 0.480-0.520, or 0.485-0.520, 0.490-0.520, or 0.495-0.520.

As noted above, the waxy tapioca starches of the disclosure are octenylsuccinylated, with a degree of octenylsuccinylation of at least 1.0 wt % on a dry solids basis. In various embodiments, a waxy tapioca starch as otherwise described herein has a degree of octenylsuccinylation of at least 1.2 wt %, e.g., at least 1.3 wt %. In various embodiments, a waxy tapioca starch as otherwise described herein has a degree of octenylsuccinylation of at least 1.4 wt %, e.g., at least 1.5 wt %. In various embodiments, a waxy tapioca starch has a degree of octenylsuccinylation of at least 1.6 wt %, e.g., at least 1.8 wt %. In various embodiments, a waxy tapioca starch has a degree of octenylsuccinylation of at least 2.0 wt %, e.g., at least 2.2 wt %. For example, in some embodiments, a waxy tapioca starch as otherwise described herein has a degree of octenylsuccinylation in the range of 1.0-5.0 wt %, e.g., 1.2-5.0 wt %, or 1.3-5.0 wt %, or 1.4-5.0 wt %, or 1.5-5.0 wt %, or 1.6-5.0 wt %, or 1.8-5.0 wt %, or 2.0-5.0 wt %, or 2.2-5.0 wt %. In some embodiments, a waxy tapioca starch as otherwise described herein has a degree of octenylsuccinylation in the range of 1.0-4.0 wt %, e.g., 1.2-4.0 wt %, or 1.3-4.0 wt %, or 1.4-4.0 wt %, or 1.5-4.0 wt %, or 1.6-4.0 wt %, or 1.8-4.0 wt %, or 2.0-4.0 wt %, or 2.2-4.0 wt %. In some embodiments, a waxy tapioca starch as otherwise described herein has a degree of octenylsuccinylation in the range of 1.0-3.0 wt %, e.g., 1.2-3.0 wt %, or 1.3-3.0 wt %, or 1.4-3.0 wt %, or 1.5-3.0 wt %, or 1.6-3.0 wt %, or 1.8-3.0 wt %, or 2.0-3.0 wt %, or 2.2-3.0 wt %. In some embodiments, a waxy tapioca starch as otherwise described herein has a degree of octenylsuccinylation in the range of 1.0-2.8 wt %, e.g., 1.2-2.8 wt %, or 1.3-2.8 wt %, or 1.4-2.8 wt %, or 1.5-2.8 wt %, or 1.6-2.8 wt %, or 1.8-2.8 wt %, or 2.0-2.8 wt %, or 2.2-2.8 wt %. In some embodiments, a waxy tapioca starch as otherwise described herein has a degree of octenylsuccinylation in the range of 1.0-2.5 wt %, e.g., 1.2-2.5 wt %, or 1.3-2.5 wt %, or 1.4-2.5 wt %, or 1.5-2.5 wt %, or 1.6-2.5 wt %, or 1.8-2.5 wt %, or 2.0-2.5 wt %. In some embodiments, a waxy tapioca starch as otherwise described herein has a degree of octenylsuccinylation in the range of 1.0-2.2 wt %, e.g., 1.2-2.2 wt %, or 1.3-2.2 wt %, or 1.4-2.2 wt %, or 1.5-2.2 wt %, or 1.6-2.2 wt %, or 1.8-2.2 wt %. In some embodiments, a waxy tapioca starch as otherwise described herein has a degree of octenylsuccinylation of no more than 3.0 wt %, e.g., no more than 2.8 wt %, or no more than 2.5 wt %, or no more than 2.2 wt %. The degree of octenylsuccinylation is quantified as weight percent of bound octenylsuccinylate residues as a fraction of the total weight of the waxy tapioca starch on a dry solids basis, which can be determined as follows: 0.35 g of starch sample is weighed into a tared 25.0 mL volumetric flask. 5 mL deionized water and 2 mL 1 N NaOH are added, and the sample is incubated at 80° C. for one hour. The sample is then cooled slightly 2.0 mL 1 N HCl is added. 5 mL of acetonitrile are added to precipitate the starch, then the volumetric flask is filled to volume with mobile phase (55:45 volume ratio of water:acetonitrile) and shaken to mix well. The sample solution is centrifuged into a centrifuge tube and centrifuged at 5500-5900 rpm for 10-12 minutes or until solution is clear, then filtered through a 0.45 μm filter into an HPLC vial. HPLC is used to determine the concentration of octenylsuccinylate in the sample, which can be related back to the amount of octenylsuccinylate bound to the starch. The person of ordinary skill in the art will select appropriate chromatographic conditions; in the Examples described herein, a Waters 2695 Separations Module equipped with a Waters 2487 Dual A Absorbance Detector and a Phenomenex Gemini C18 4.60×150 mm column was used, at flow rate of 1 mL/min and detection wavelength of 203 nm. In some embodiments as described herein, the degree of octenylsuccinylation is quantified according to the Food and Agriculture Committee/World Health Organization Joint Expert Committee on Food Additives (FOA JECFA) monographs, page 73.

The person of ordinary skill in the art can use any desirable octenylsuccinylation method. In an example of such a procedure, the waxy tapioca starch, be it pregelatinized or not, is slurried with stirring in water The person of ordinary skill in the art will select a solids loading that provides for desired stirrability of the slurry; 30-40% solids is a common value, but more or less can be used. The pH of the starch slurry is adjusted in the range of 8.0-9.0. Octenylsuccinic anhydride is slowly added, and the pH is maintained at a slightly basic pH, e.g., 7.6-9.0 by the addition of an aqueous solution of a base, such as: sodium hydroxide, sodium carbonate, or sodium bicarbonate. The starch slurry is allowed to mix for 15-120 minutes to allow the reaction to complete. The reaction efficiency is typically 60-85%, i.e., 60-85% of the octenylsuccinic anhydride reacts with the starch and is bound in the final product; the person of ordinary skill in the art can determine an appropriate amount of octenylsuccinic anhydride reagent to add, along with other parameters, to provide a desired degree of octenylsuccinylation. Once the addition is complete, the pH is lowered, for example 4.5-7.0, by the addition of acid, such as hydrochloric or sulfuric, for example 1-12 N. The slurry is dewatered and washed with water to remove the salts, by standard procedures, such as centrifuge or filtration, followed by drying by typical procedures, such as air drying, oven drying, tray drying, flash drying, or belt drying. If desired, the resulting starch can be pregelatinized as described above. But this is not necessary, because a non-gelatinized starch can likewise be used as a starch emulsifier feed in the preparation of an emulsion.

Waxy tapioca starches of the disclosure can be provided with a wide range of viscosities in an aqueous suspension, and, as the person of ordinary skill in the art will appreciate, a desired viscosity of a waxy tapioca starch of the disclosure will depend on its desired end use. For example, in some end uses, like salad dressings and sauces, it is desired that a starch emulsifier also provide an increased viscosity; in such cases, a higher-viscosity waxy tapioca starch can be used. In other end uses, such as beverages, it is desired that a starch emulsifier provide emulsification but little contribution to viscosity. In either of these use cases, it can be advantageous for an aqueous phase comprising the starch to have a similar viscosity as the hydrophobic phase to provide an emulsion, as described herein. By having similar viscosities, better emulsification can be obtained. For example, in some embodiments, the aqueous phase comprising the waxy tapioca starch as a viscosity within at least 50% of the hydrophobic phase, or within at least 25% of the hydrophobic phase, or within at least 10% of the hydrophobic phase, or within at least 5% of the hydrophobic phase, or within at least 2% of the hydrophobic phase. The viscosity of each of these phases can be measured by a viscometer.

In cases where the viscosity of a waxy tapioca starch of the disclosure is higher than desirable for a given application, it can be thinned to provide the desired viscosity, e.g., using any of a variety of methods. For example, in various embodiments, the waxy tapioca starch is acid-thinned, enzyme-thinned and/or shear thinned. In various embodiments, acid thinning is used. In one example of an acid thinning process, waxy tapioca starch is dispersed in water at, for example 25-45 wt % solids. The pH of the resulting slurry is adjusted to less than 2.0 with a mineral acid, such as hydrochloric or sulfuric acid, and acid-catalyzed hydrolysis is allowed to proceed for a time sufficient to thin the starch by an appropriate degree. Viscosity can be monitored by measuring samples with a Rapid Visco Analyzer. Once the starch has reached the desired viscosity, the pH is adjusted to >7.6 by the addition of an aqueous solution of a base (e.g., sodium hydroxide, sodium carbonate, sodium bicarbonate). The thinned starch can be collected by filtration and washed. Of course other acid thinning processes can be used. Shear thinning and enzyme thinning processes can also be suitable. However, in some embodiments, enzyme thinning is not used.

One typical measure for a starch product's contribution to viscosity is Water Fluidity, which is an empirical test of viscosity measured on a scale of 0-90, in which fluidity is inversely proportional of viscosity. As used herein, Water Fluidity is measured as an alkaline water fluidity value, as follows: 50 g of a 40 wt % dry solids dispersion of the starch in deionized water is mixed with 70 mL of 2N NaOH for three minutes. The baseline time of a water fluidity funnel is determined by measuring the amount of time it takes 100 ml of deionized water to pass through the funnel. The volume of the starch sample that passes through the funnel in the predetermined time is measured; that volume, in mL, is the Water Fluidity. This measurement is normalized to water and as such a variety of water fluidity funnels can be used. The measurements described in the Examples were obtained using a water fluidity funnel having a cone tapering from a 100 mm opening down to 8.7 mm inner diameter over 77 mm, and a neck tapering from 8.7 mm to 7.0 mm over 44 mm. The quantifications of Water Fluidity for purposes this disclosure are determined in this manner. In various embodiments as otherwise described herein, a waxy tapioca starch of the disclosure has a Water Fluidity up to 70 mL. For example, in various embodiments, the Water Fluidity of the waxy tapioca starch is up to 60 mL, or up to 50 mL. In various embodiments, the Water Fluidity of the waxy tapioca starch is in the range of 10-70 mL. e.g., 10-60 mL, or 10-50 mL, or 20-70 mL, or 20-60 mL, or 20-50 mL, or 30-70 mL, or 30-60 mL, or 30-50 mL.

As described above, the desired viscosity of a waxy tapioca starch of the disclosure will depend on the end use. Similarly, the desired Water Fluidity of a waxy tapioca starch of the disclosure will also depend on its end use. For example, in some end uses when it is desired for the starch emulsifier to also provide an increased viscosity, such as in salad dressings and sauces, a waxy tapioca starch of the disclosure may have a Water Fluidity of up to 70 mL, e.g., up to 60 mL, or up to 50 mL. In various embodiments, the Water Fluidity of the waxy tapioca starch is in the range of 10-70 mL, e.g., 10-60 mL, or 10-50 mL, or 20-70 mL, or 20-60 mL, or 20-50 mL, or 30-70 mL, or 30-60 mL, or 30-50 mL.

Alternatively, when it is desired that the starch emulsifier provides emulsification but does not contribute substantially to the viscosity, starches with even high Water Fluidities may be provided. For example, in some embodiments as described herein, a waxy tapioca starch of the disclosure has a Water Fluidity of at least 60 mL, e.g., at least 70 mL, or at least 75 mL, or at least 80 mL, or at least 85 mL, or at least 90 mL. In various embodiments, the Water Fluidity of the waxy tapioca starch is in the range of 60-95 mL, e.g., 60-90 mL, or 60-85 mL, or 60-80 mL, or 65-95 mL, or 65-90 mL, or 65-85 mL, or 65-80 mL, or 70-95 mL, 70-90 mL, or 70-85 mL, or 70-80 mL, or 80-95 mL, or 80-90 mL, or 90-95 mL. The person of ordinary skill in the art can provide a starch with a desired degree of thinning (or no thinning at all) to meet these, or other Water Fluidity values.

In another measure of viscosity of a starch, viscosity is measured by RVA at 5% solids in a pH 6.5 phosphate buffer at 1% NaCl at a stir rate of 160 rpm. The initial temperature of the analysis is 50° C.; the temperature is ramped linearly up to 95° C. over 3 minutes, then held at 95° C. for 20 minutes, then ramped linearly down to 50° C. over 3 minutes, then held at 50° C. for 9 minutes, after which time the viscosity is measured. Notably, when a pasting peak is displayed at times of about 2-5 minutes, the final viscosity measured is higher than the pasting peak viscosity. When the pasting peak is absent, the viscosity during the 95° C. hold is flat, or increases. The starch products of the present disclosure can have a variety of viscosities as measured by a Rapid Visco Analyzer (RVA). For example, in certain embodiments a starch product as otherwise described herein can have a viscosity as measured by RVA is 5-2000 cP at 5% solids. In certain such embodiments, the viscosity as measured by RVA at 5% solids is in the range of 300-2000 cP, or 300-1800 cP, or 300-1600 cP, or 500-2000 cP, or 500-1800 cP, or 500-1600 cP, or 500-1400 cP, or 500-1200 cP, or 800-2000 cP, or 800-1800 cP, or 800-1600 cP, or 800-1400 cP, or 800-1200 cP. In certain such embodiments, the viscosity as measured by RVA at 5% solids is in the range of 5-800 cP, or 5-600 cP, or 5-400 cP, or 5-200 cP, or 100-1000 cP, or 100-800 cP, or 100-600 cP, or 100-400 cP, or 300-1000 cP, or 300-800 cP, or 300-600 cP, or 500-1000 cP, or 500-800 cP. In certain embodiments, a starch product as otherwise described herein can have a viscosity as measured by RVA in the range of 100-1000 cP at 20% solids. For example, in various embodiments, the viscosity as measured by RVA at 20% solids is in the range of 100-800 cP, or 100-600 cP, or 100-400 cP, or 100-200 cP, or 300-1000 cP, or 300-800 cP, or 300-600 cP, or 300-400 cP, or 500-1000 cP, or 500-800 cP, or 500-600 cP. In certain embodiments, a starch product as otherwise described herein can have a viscosity as measured by RVA in the range of 100-1200 cP at 45% solids. For example, in various embodiments, the viscosity as measured by RVA at 45% solids in the range of 100-1000 cP, or 100-800 cP, or 100-600 cP, or 300-1200 cP, or 300-1000 cP, or 300-800 cP, or 300-600 cP, or 500-1200 cP, or 500-1000 cP, or 500-800 cP, or 500-600 cP. Here, too, the person of ordinary skill in the art can provide a starch with a desired degree of thinning (or no thinning at all) to meet a desired RVA viscosity value.

Notably, starches of the disclosure are not inhibited. As the person of ordinary skill in the art will appreciate, an inhibited starch is one that is treated, chemically or otherwise, to resist granular disintegration when heated. While in many contexts inhibited starches are desirable, the starches of the present disclosure are not inhibited. As used herein, the term “inhibited starch” means a starch that exhibits “process tolerance”. As used herein, the term “process tolerance” means that the starch particles swell in water when cooked, but substantially retain their particulate natural throughout the process. Process-tolerant starches resist breaking down into fragments and resist dissolution when processed. Inhibited starches may vary with respect to their degree-of-inhibition, as characterized by their observed microscopy and swelling volume. Degree-of-inhibition can be assessed by cooking the starch in water (typically cook at 95° C. for 30 minutes with hand stirring in the first 6 minutes) and then observing the cook under microscope. Starches that have not been inhibited will have few granules and fragments, as they tend to dissolve in water during cooking. Starches that have been inhibited will show swollen intact particles under microscope, with starches that have been highly inhibited exhibit small and dark particles and starches that have been slightly inhibited exhibit large and light particles. Alternatively, degree-of-inhibition can be assessed through the measurement of sedimentation volume. As used herein, sedimentation volume is the volume occupied by one gram of cooked starch (dry basis) in 100 grams (i.e. total, including the starch) of salted buffer solution. This value is also known in the art as “swelling volume.” As used herein, the “salted buffer solution” refers to a solution prepared according to the following steps:
Using a top loader balance, weigh out 20 grams of sodium chloride into a 2 liter volumetric flask containing a stir bar;
To this add RVA pH 6.5 buffer (phosphate buffer purchased from Ricca Chemical Company) so that the flask is at least half full;
Stir to mix until sodium chloride is dissolved;
Add additional RVA pH 6.5 buffer to a final volume of 2 liters;

Sedimentation volumes as described herein are determined by first cooking the starch at 5% solids in the salted buffer solution by suspending a container containing the slurry in a 95° C. water bath and stirring with a glass rod or metal spatula for 6 minutes, then covering the container and allowing the paste to remain at 95° C. for an additional 20 minutes. The container is removed from the bath and allowed to cool on the bench. The resulting paste is brought back to the initial weight by addition of water (i.e. to replace any evaporated water) and mixed well. 20.0 g of the paste (which contains 1.0 g starch) is weighted into a 100 mL graduated cylinder containing salted buffer solution, and the total weight of the mixture in the cylinder is brought to 100 g using the buffer. The cylinder is allowed to sit undisturbed for 24 hours. The volume occupied by the starch sediment (i.e., as read in the cylinder) is the sedimentation volume for 1 g of starch, i.e., in units of ml/g.

The waxy tapioca starches of the disclosure are not inhibited and therefore do not have the substantial sedimentation volumes indicative of inhibited starch. In many desirable embodiments of the disclosure, especially with thinned starches, no boundary between sedimented starch and supernatant is observed. The dispersed starch may appear transparent or translucent, but substantially no sediment is observed. Of course, in some embodiments there may be a small amount of solid at the bottom of the cylinder in the sedimentation volume measurement, representing undispersible material in the sample, but this will correspond to a measurement of less than 1 mL/g, e.g., less than 0.8 mL/g or 0.5 ml/g. Put another way, in various embodiments, the waxy tapioca starches of the disclosure do not have a measured sedimentation volume in the range of 1-70 mL/g.

The non-inhibited waxy starches based tapioca described herein can be made with relatively little color. For example, certain embodiments of the non-inhibited waxy starches based on tapioca as otherwise described herein are relatively low in color, i.e., have a Yellowness Index of no more than 10, for example, in the range of 3-10 or 5-10. In certain desirable embodiments, the starches described herein are especially low in color, i.e., the Yellowness Index is less than 8 (e.g., 3-8 or 5-8). Yellowness Index is determined via ASTM E313.

As noted above, the starches of the disclosure are octenylsuccinylated. However, the waxy tapioca starches described herein can be made without other modification. Accordingly, in various embodiments, a waxy tapioca starch as otherwise described herein is not hydroxypropylated. In various embodiments, a waxy tapioca starch as otherwise described herein is not acetylated. In various embodiments, a waxy tapioca starch as otherwise described herein is not carboxymethylated. In various embodiments, a waxy tapioca starch as otherwise described herein is not hydroxyethylated. In various embodiments, a waxy tapioca starch as otherwise described herein is not phosphated. In various embodiments, a waxy tapioca starch as otherwise described herein is not cationic or zwitterionic.

And, as the waxy tapioca starches described herein are not inhibited, they can be made without use of the cross-linkers typically used in the inhibition of starch. For example, in various embodiments, a waxy tapioca starch as otherwise described herein is not crosslinked with phosphate (e.g., using phosphorus oxychloride or metaphosphate). In various embodiments, a waxy tapioca starch as otherwise described herein is not crosslinked with adipate. In various embodiments, a waxy tapioca starch as otherwise described herein is not crosslinked with epichlorohydrin. In various embodiments, a waxy tapioca starch as otherwise described herein is not crosslinked with acrolein.

The waxy tapioca starches of the disclosure are useful, for example, as emulsifiers. For example, a pregelatinized starch of the disclosure can be used to make an emulsion without cooking, while a non-pregelatinized starch can be used to make an emulsion in a process that includes cooking.

Accordingly, another aspect of the disclosure is an emulsion comprising an emulsified phase that is a hydrophobic phase emulsified within an aqueous phase, stabilized by a gelatinized starch that is the gelatinization product of a waxy tapioca starch having an amylopectin content in the range of 90-100%; and a degree of octenylsuccinylation in an amount of at least 1.0 wt % on a dry solids basis, wherein the starch is not inhibited. The hydrophobic phase can be, e.g., an oil or fat phase. The waxy tapioca starch can be as described in any embodiment herein or any combination thereof. In particular, as noted above, a waxy tapioca starch of the disclosure may be provided in the emulsion having a viscosity and a Water Fluidity that are suitable for the end use.

Notably, the starches described herein are not inhibited, and so, when gelatinized and in an aqueous system the starch granules in will substantially disintegrate. Accordingly, the emulsions of the disclosure are not so-called “Pickering emulsions” in which small particulate materials stabilize an emulsion.

The person of ordinary skill in the art can adapt conventional emulsification techniques for use in making the emulsions described herein. For example, another aspect of the disclosure is a method for making an emulsion as described herein. One such method includes mixing a hydrophobic phase, an aqueous phase and a waxy tapioca starch described in any embodiment herein or any combination thereof under conditions sufficient to form the emulsion.

These methods will often involve mixing under shear, e.g., in a colloid mill, microfluidizer, homogenizer (e.g., Gaulin, APV), and the like. In some cases, such processing to form the emulsion will further thin the starch.

In various embodiments, the processing to form the emulsion also gelatinizes the starch. Accordingly, in such embodiments an ungelatinized waxy tapioca starch can be used as an ingredient. The waxy tapioca starch can alternatively be gelatinized in a separate step before the emulsification. And of course, as described herein the waxy tapioca starch can be provided as an ingredient in pregelatinized form, so that further gelatinization when making an emulsion is not necessary.

The amount of starch used in the emulsions described herein can vary, but can be at generally low amounts. In various embodiments as otherwise described herein, the waxy tapioca starch is present in an amount of at least 1 wt % of the hydrophobic phase, e.g., at least 2 wt %, at least 5 wt %, or at least 10 wt %. In various embodiments, the amount of the waxy tapioca starch in the emulsion is in the range of 1-200 wt %, e.g., 2-200 wt %, or 5-200 wt %, or 10-200 wt %, or 1-100 wt %, or 2-100 wt %, or 5-100 wt %, or 10-100 wt %, or 1-50 wt %, or 2-50 wt %, or 5-50 wt %, or 10-50 wt %, or 1-25 wt %, or 2-25 wt %, or 5-25 wt %, or 10-25 wt % of the hydrophobic phase. The person of ordinary skill in the art will determine a desired use rate of the starch based on the disclosure herein. The amount of the “hydrophobic phase” in an emulsion can be determined with reference to the ingredients used to make the emulsion; contributions to the amount of the hydrophobic phase for materials that substantially partition between aqueous and hydrophobic phases can be calculated with respect to partition coefficients.

Emulsions can be made with a variety of droplet sizes, depending, e.g., on the identities and the relative amounts of the starch and the emulsified phase, and the conditions used to emulsify. For example, in various embodiments as otherwise described herein, the emulsion has a median emulsion droplet size (i.e., of the emulsified phase) in the range of 0.2-100 microns, e.g., 0.2-75 microns, or 0.2-50 microns, or 0.2-25 microns, or 0.2-15 microns, or 0.2-5 microns, or 0.5-100 microns, or 0.5-50 microns, or 0.5-25 microns, or 0.5-15 microns, or 0.5-5 microns.

Emulsions can be made with a variety of amounts of aqueous phase and hydrophobic phase. For example, in various embodiments, the aqueous phase is present in the emulsion in an amount in the range of at least 30 wt %, e.g., at least 35 wt %, or at least 40%, or at least 45%, or at least 50 wt %, or at least 60 wt %, or at least 65 wt %, or at least 70 wt %, or at least 75 wt %, or at least 80 wt %, or at least 85 wt %. In various embodiments, the hydrophobic phase is present in an amount in the range of 0.5-70 wt %, e.g., 0.5-50 wt %, or 0.5-35 wt %, or 0.5-15 wt %. Like the hydrophobic phase, the amount of the “aqueous phase” in an emulsion can be determined with reference to the ingredients used to make the emulsion; contributions to the amount of the aqueous phase for materials that substantially partition between aqueous and hydrophobic phases can be calculated with respect to partition coefficients.

The emulsions described herein can find use in a wide variety of products. The present inventors have determined that the starches described herein can provide good stabilization of emulsions without an undesirable effect on flavor. The starches can be provided with a desired tolerance to processing variables such as heat, shear and extremes of pH, particularly for a significant time under such conditions, and with a rheological and textural stability over a desired shelf-life. In various embodiments as described herein, a waxy tapioca starch of the disclosures do not suffer from retrogradation over the desired shelf-life. As such, in various embodiments, a waxy tapioca starch of the disclosure do not gel over the desired shelf life of the product, and in particular embodiments, the waxy tapioca starch does not gel under refrigeration condition (e.g., about 4° C.) over the shelf life of the product.

For example, in various embodiments, an emulsion as otherwise described herein is in the form of a food or beverage product that may or may not require refrigeration. In various embodiments, the food or beverage product is a gravy, a sauce (e.g., a mayonnaise, a white sauce or a cheese sauce), a soup, or a stew. In various embodiments, the food or beverage product is a dressing such as a salad dressing (e.g., pourable or spoonable). In various embodiments, the food or beverage product is a dairy product, e.g. a yogurt, a sour cream, an ice cream or an ice milk. In various embodiments, the food or beverage product is a dairy substitute, such as a non-dairy creamer, a plant milk (such as an oat milk, a soy milk or a nut milk) or a food or beverage based thereon (e.g., an ice cream analog based on such milks), or a margarine. In various embodiments, the food or beverage product is a cream filling or a custard. In various embodiments, the food or beverage product is a confectionary, e.g., a chocolate. In various embodiments, the food or beverage product is a mousse, a smoothie or a shake. However, the person of ordinary skill in the art will appreciate that a wide variety of other food and beverage products can advantageously include emulsions as described herein.

The emulsions can also find use in personal care products. A wide variety of personal care products, many in the forms of lotions or creams, include emulsified systems. Examples include shaving creams, skin lotions, hair conditioners, hair products, e.g., in the form of mousses and geis, sunscreens, facial masks, bath oils, and body washes. Other products, like nutraceutical or pharmaceutical compositions (e.g., including an oily active dispersed in an aqueous carrier, e.g., an ointment or a liniment, so-called “fat emulsions” or “lipid emulsions” used, e.g., for intravenous nutritional supplementation, and the like), can also be provided using the emulsions of the disclosure. Notably, the starches of the disclosure can provide good emulsification ability and good stability to refrigeration, even while being plant-sourced and biodegradable.

As the person of ordinary skill in the art will appreciate, some food and beverage products can be in the form of both an emulsion and a foam. For example, desserts like ice cream and mousses can often include both emulsified fat and air bubbles. Such products are considered emulsions for the purposes of this disclosure.

Further description is provided with respect to the Examples, below.

### Example 1—Acid-Thinned Octenylsuccinylated Waxy Tapioca Starch

An acid-thinned octenylsuccinylated waxy tapioca starch was prepared by acid thinning a waxy tapioca starch followed by treatment with octenylsuccinic anhydride, as described herein. The resulting starch had a Water Fluidity of 45-50 mL, and an octenylsuccinylate content of ˜2 wt %. Comparative starches were prepared using substantially identical conditions but with waxy corn starch and non-waxy tapioca starch as starch sources.

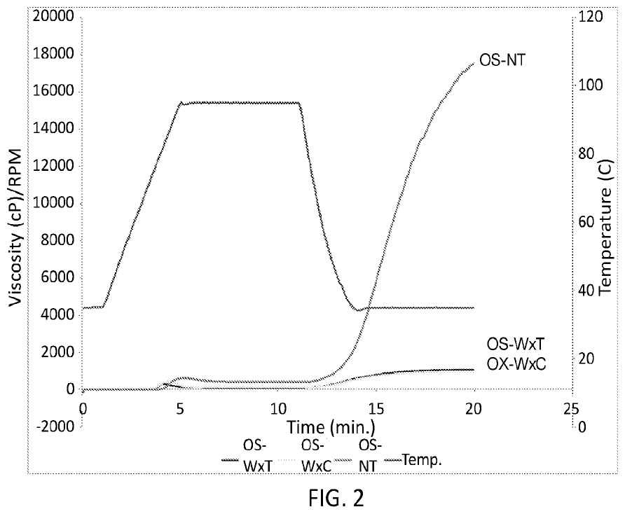

An RVA viscosity measurement was performed. The measurement sample was 37 wt % dry solids in RVA buffer; the run profile was 20 min run, 160 rpm, initial 35° C., 6 minutes hold at 95° C., 6 minute hold at 35° C. A plot is shown in FIG. 2, comparing the acid-thinned waxy tapioca starch (OS-WxT) with acid-thinned non-waxy tapioca starch (OS-NT) and acid-thinned waxy corn starch (OS-WxC). The final viscosities of the acid-thinned waxy tapioca starch and the acid-thinned waxy corn starch under these conditions is about 1000 cP, while the final viscosity of the acid thinned non-waxy tapioca starch is in excess of 17000 cP.

### Example 2—Octenylsuccinylated Waxy Tapioca Starch

An octenylsuccinylated waxy tapioca starch was prepared by treatment of waxy tapioca starch with octenylsuccinic anhydride, as described herein. The resulting starch had a Water Fluidity of 0 mL (i.e., no starch passed through the funnel on the timescale of the experiment), and an octenylsuccinylate content of ˜2 wt %. Comparative starches were prepared using substantially identical conditions but with waxy corn starch and non-waxy tapioca starch as starch sources.

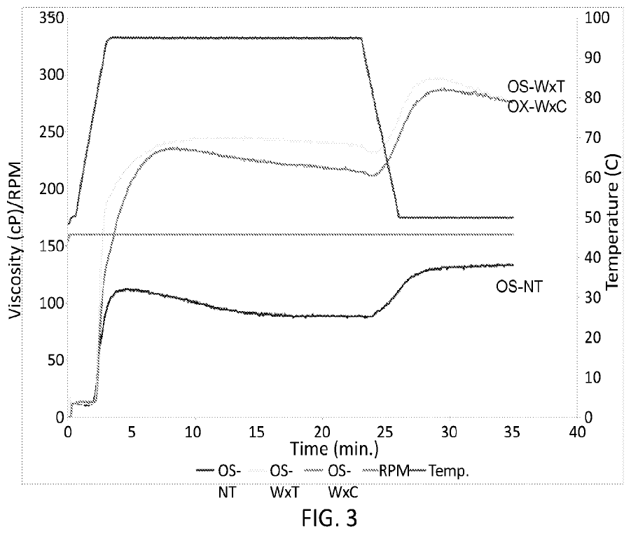

An RVA viscosity measurement was performed. The measurement sample was 2.75 wt % dry solids in RVA buffer; the run profile was 20 min run, 160 rpm, initial 50° C., 20 minutes hold at 95° C., 9 minute hold at 50° C. A plot is shown in FIG. 3, comparing the unthinned waxy tapioca starch with unthinned non-waxy tapioca starch and unthinned waxy corn starch; the final viscosities of the samples based on waxy tapioca starch, waxy corn starch and non-waxy tapioca starch are 277 cP, 277 cP, and 133 cP, respectively.

### Example 3—Branch Chain Length Distribution

Branch chain length distributions on the starches of Example 1 and Example 2 (OS-WxT), as well as for substantively identically-treated non-waxy tapioca starch (OS-NT) and waxy corn starch (OS-WxC) were determined as described above. Results are provided in the tables below:

Chain length distribution of acid-thinned OS-starch (% relative area).

| SAMPLE | DP1-5 | DP6-12 | DP13-24 | DP25-36 | DP37+ |
|---|---|---|---|---|---|
| OS-WxT | 2.08 ± 0.05 | 25.2 ± 0.3 | 50.2 ± 0.2 | 16.6 ± 0.3 | 5.9 ± 0.1 |
| OS-NT | 1.38 ± 0.00 | 26.14 ± 0.04 | 50.30 ± 0.01 | 15.99 ± 0.03 | 6.18 ± 0.00 |
| OS-WxC | 1.91 ± 0.01 | 23.7 ± 0.1 | 53.3 ± 0.1 | 16.1 ± 0.1 | 5.01 ± 0.03 |

Chain length distribution of unthinned OS-starch (% relative area).

| SAMPLE | DP1-5 | DP6-12 | DP13-24 | DP25-36 | DP37+ |
|---|---|---|---|---|---|
| OS-WxT | 0.52 ± 0.02 | 26.3 ± 0.3 | 51.1 ± 0.1 | 15.4 ± 0.2 | 6.7 ± 0.1 |
| OS-NT | 0.50 ± 0.00 | 26.6 ± 0.5 | 50.7 ± 0.2 | 15.5 ± 0.4 | 6.7 ± 0.2 |
| OS-WxC | 0.56 ± 0.01 | 23.27 ± 3.15 | 56.19 ± 2.02 | 14.86 ± 0.92 | 5.13 ± 0.21 |

### Example 4—Emulsion

A flavor oil encapsulation system was used to evaluate the performance of the octenylsuccinylated acid-thinned waxy tapioca starch and the substantively identically-treated octenylsuccinylated acid-thinned waxy corn starch of Example 1 for their emulsification properties, especially with respect to cold storage.

The system contained 10 wt % orange oil, 10 wt % of the octenylsuccinylated acid-thinned starch under test, and 80 wt % water. The ingredients were mixed and homogenized with a combination of high-speed homogenization (11000 rpm for 3 min) using an IKA T25 high-speed homogenizer (IKA, North Carolina, USA) and microfluidization (7000 psi and 3 passes) using M-110T Microfluidizer Processor (Newton, Massachusetts, USA).

The emulsions were analyzed with respect to oil droplet size distribution and storage stability under refrigeration conditions. The particle size distribution of freshly-prepared emulsion was measured with a Laser Diffraction Particle Size Analyzer Universal Liquid Module (LS 13 320, Beckman Coulter Life Science, Indianapolis, IN, USA).

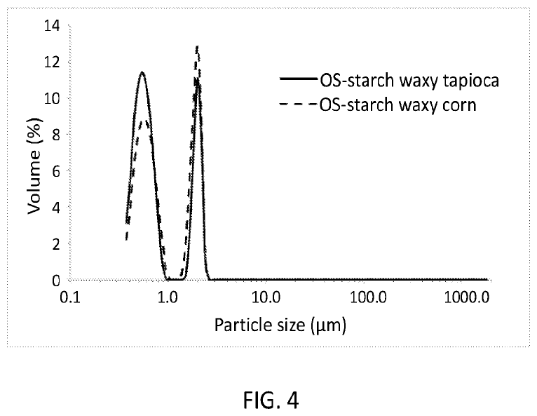

As shown FIG. 4, the emulsion made with the waxy tapioca starch of Example 1 has a higher amount of oil droplets with diameter less than 1 μm than does the emulsion made with the similar waxy corn starch. This suggests somewhat improved emulsification properties for the waxy tapioca starch.

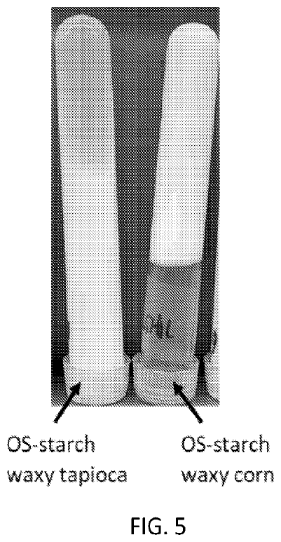

More critically, the emulsion made with the waxy tapioca starch of Example 1 demonstrates improved storage stability under refrigeration conditions. The emulsions were refrigerated for 18 days at 4° C. As shown by the inverted sample tubes in FIG. 5, the emulsion stabilized by the waxy tapioca starch of Example 1 remained emulsified and flowable after refrigerated storage, while the emulsion based on the waxy corn starch formed a gel and was not flowable after refrigerated storage.

### Example 5—Pregelatinized Octenylsuccinylated Waxy Tapioca Starch

A pregelatinized octenylsuccinylated waxy tapioca starch was prepared by dispersing an octenylsuccinylated waxy tapioca starch, as described herein, in deionized water at 20% (w/w). The starch slurry was then cooked at 90° C. for 30 minutes and then pregelatinized using a spray dryer (Buchi Mini Spray Dyer (B-290) under the following parameters:

| Inlet Temperature | 145° | C. |
|---|---|---|
| Outlet Temperature | 85° | C. |
| Aspirator | 90% | |
| Pump rate | 20% | |
| Spray gas flow | 35 | mm |

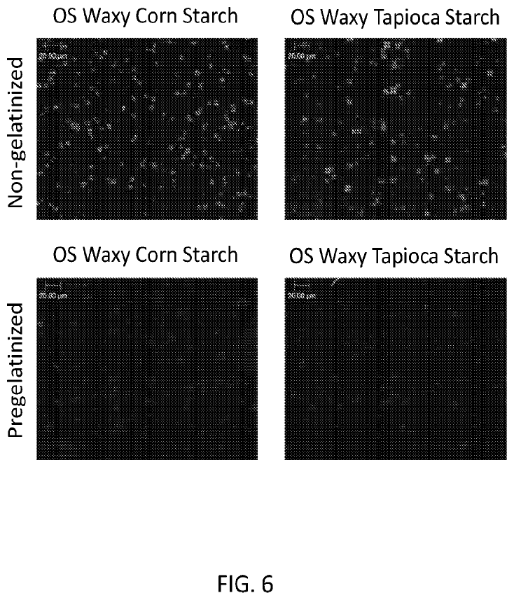

Comparative starches were prepared using substantially identical conditions but with an octenylsuccinylated waxy corn starch as the starch source. The products were collected and examined with light microscopy, the result of which are shown in FIG. 6. As shown in FIG. 6, both the pregelatinized starches lost their birefringence, which confirms successful pregelatinization.

### Example 6—Freeze/Thaw Stability of Pregelatinized Octenylsuccinylated Waxy Tapioca Starch

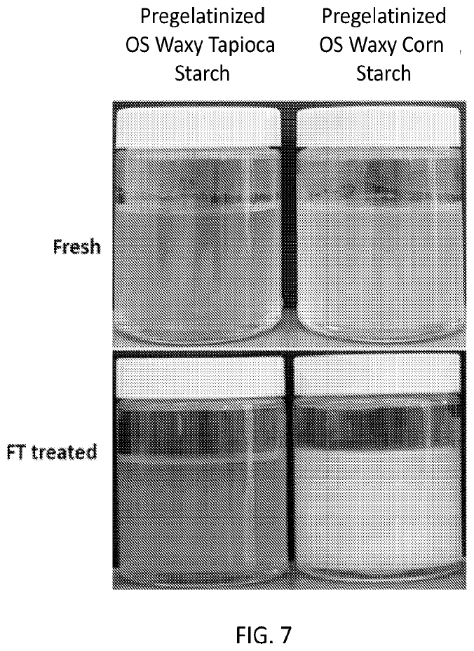

The pregelatinized octenylsuccinylated waxy tapioca starch, as prepared in Example 5, was dispersed in deionized water at 7% solids by stirring at room temperature. The dispersion was aliquoted into 75 g samples in 125 ml glass jars. The samples were then subjected to freeze/thaw treatment. The freeze/thaw treatment includes the following steps:
A. freeze samples in freezer (e.g., about −18° C.) for at least 16 hours.
B. thaw samples at room temperature for at least 6 hours.
   For comparison, the pregelatinized octenylsuccinylated waxy corn starch of Example 5 was also subjected to the freeze/thaw treatment as described above. The results of the treatment for both starches are shown in FIG. 7. As can be seen in the photo of FIG. 7, the pregelatinized octenylsuccinylated waxy tapioca starch maintains its clarity after freeze/thaw treatment, while the pregelatinized octenylsuccinylated waxy corn starch dispersion became whiter with starch aggregate settling at the bottom of jar. The aggregate is indicative of retrogradation of the pre-gelatinized octenylsuccinylated waxy corn starch. Accordingly, the pregelatinized octenylsuccinylated waxy tapioca starch provide a better freeze/thaw stability than the pregelatinized octenylsuccinylated waxy corn starch. The freeze/thaw stability is indicative of better cold-storage properties for the pregelatinized octenylsuccinylated waxy tapioca starch.

### Example 7—Emulsion Using Pregelatinized Octenylsuccinylated Waxy Tapioca Starch

To prepare an emulsion using the pregelatinized octenylsuccinylated waxy tapioca starch, as described in Example 5, the starch was dispersed in water via stirring at room temperature of 2 hours to prepare a starch emulsifier. A separate starch thickener was dispersed in water and cooked for 30 minutes at 95° C. The starch emulsifier and the starch thickener dispersion was mixed with vinegar and oil. The mixture was then homogenized using a bench top mixer (Silverson Mixer) at 3000 rpm for 10 minutes. Comparative emulsions were prepared without the use of a starch emulsifier and with a pregelatinized octenylsuccinylated waxy corn starch, as described in Example 5, made under substantially identical conditions. The full formulation of the emulsion is as follows:

| Ingredient | % Mass |
|---|---|
| Water | 51.125 |
| Vinegar, 10% | 25 |
| Vegetable oil | 17.5 |
| Cook up starch thickener | 4.375 |
| Starch emulsifier | 1.75 |
| Sodium benzoate | 0.1 |
| Total | 100 |

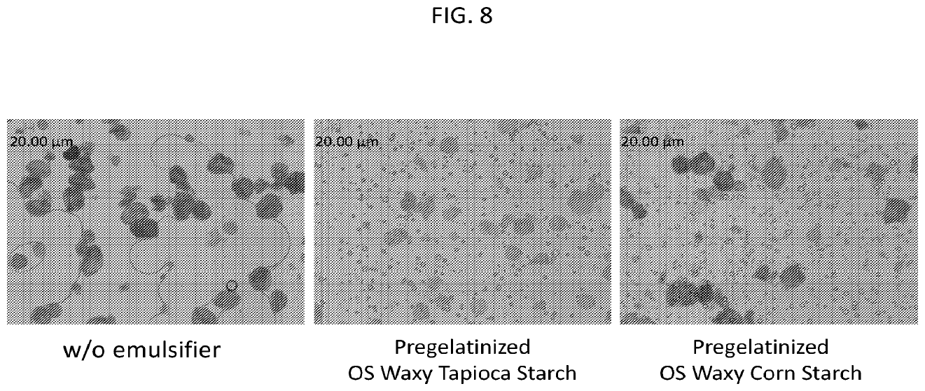

The emulsions were characterized under a microscope (200× magnification) to assess the oil droplet size distribution. The microscopy image are shown in FIG. 8. As shown in FIG. 8, when pregelatinized octenylsuccinylated waxy tapioca starch was used, the emulsion has uniformly distributed oil droplets, which is encapsulated by the starch. In contrast, the emulsion without the starch emulsifier shows oil that is not emulsified. Such a result confirmed the emulsification efficiency of pregelatinized octenylsuccinylated waxy tapioca starch. Additionally, the Brookfield viscosity of the emulsions were measured immediately after preparation and after storing at 4° C. for 3 weeks. The Brookfield viscosity was measuring using the following parameters: 20 rpm, 20 seconds, spindle #27, at 25° C. The emulsion with pregelatinized octenylsuccinylated waxy tapioca starch showed a 21% increase in viscosity after storage, while the emulsion with pregelatinized octenylsuccinylated waxy corn starch showed a 32% increase in viscosity after storage. Accordingly, the pregelatinized octenylsuccinylated waxy tapioca starch showed improved cold-storage properties over the pregelatinized octenylsuccinylated waxy corn starch.

Additional aspects of the disclosure are provided by the following enumerated embodiments, which can be combined in any number and in any combination not technically or logically inconsistent.

Embodiment 1. A waxy tapioca starch having
an amylopectin content in the range of 90-100%; and
a degree of octenylsuccinylation of at least 1.0 wt % on a dry solids basis,
   wherein
the starch is not inhibited, and
the starch is pregelatinized.
   Embodiment 2. A waxy tapioca starch having
an amylopectin content in the range of 90-100 wt % and
a degree of octenyisuccinylation of at least 1.0 wt % on a dry solids basis,
   wherein
the starch is not inhibited.
   Embodiment 3. The waxy tapioca starch according to embodiment 1 or embodiment 2, having an amylopectin content in the range of 95-100%.
   Embodiment 4. The waxy tapioca starch according to embodiment 1 or embodiment 2, having an amylopectin content of at least 99%.
   Embodiment 5. The waxy tapioca starch according to embodiment 1 or embodiment 2, having an amylopectin content of at least 99.9%.
   Embodiment 6. The waxy tapioca starch according to any of embodiments 1-5, wherein the amylopectin fraction of the waxy tapioca starch has a branch chain length ratio (DP6-12)/(DP13-24) of at least 0.470, e.g., at least 0.475, wherein DP6-12 is a distribution of short-length branches having a chain length from 6-12 and DP13-24 is a distribution of short-length branches having a chain length from 13-24.
   Embodiment 7. The waxy tapioca starch according to any of embodiments 1-5, wherein the amylopectin fraction of the waxy tapioca starch has a branch chain length ratio (DP6-12)/(DP13-24) of at least 0.480, e.g., at least 0.485, wherein DP6-12 is a distribution of short-length branches having a chain length from 6-12 and DP13-24 is a distribution of short-length branches having a chain length from 13-24.
   Embodiment 8. The waxy tapioca starch according to any of embodiments 1-5, wherein the amylopectin fraction of the waxy tapioca starch has a branch chain length ratio (DP6-12)/(DP13-24) of at least 0.490, e.g., at least 0.495, wherein DP6-12 is a distribution of short-length branches having a chain length from 6-12 and DP13-24 is a distribution of short-length branches having a chain length from 13-24.
   Embodiment 9. The waxy tapioca starch according to any of embodiments 1-5, wherein the amylopectin fraction of the waxy tapioca starch has a branch chain length ratio (DP6-12)/(DP13-24) in the range of 0.470-0.540, e.g., 0.475-0.540, or 0.480-0.540, or 0.485-0.540, 0.490-0.540, or 0.495-0.540, or 0.470-0.530, or 0.475-0.530, or 0.480-0.530, or 0.485-0.530, 0.490-0.530, or 0.495-0.530, or 0.470-0.520, or 0.475-0.520, or 0.480-0.520, or 0.485-0.520, 0.490-0.520, or 0.495-0.520, in which DP6-12 is a distribution of short-length branches having a chain length from 6-12 and DP13-24 is a distribution of short-length branches having a chain length from 13-24.
   Embodiment 10. The waxy tapioca starch according to any of embodiments 1-9, wherein the starch has a degree of octenylsuccinylation of at least 1.2 wt %, e.g., at least 1.3 wt %.
   Embodiment 11. The waxy tapioca starch according to any of embodiments 1-9, wherein the starch has a degree of octenylsuccinylation of at least 1.4 wt %, e.g., at least 1.5 wt %.
   Embodiment 12. The waxy tapioca starch according to any of embodiments 1-9, wherein the starch has a degree of octenylsuccinylation of at least 1.6 wt %, e.g., at least 1.8 wt %.
   Embodiment 13. The waxy tapioca starch according to any of embodiments 1-9, wherein the starch has a degree of octenylsuccinylation of at least 2.0 wt %, e.g., at least 2.2 wt %.
   Embodiment 14. The waxy tapioca starch according to any of embodiments 1-9, wherein the starch has a degree of octenylsuccinylation in the range of 1.0-5.0 wt %, e.g., 1.2-5.0 wt %, or 1.3-5.0 wt %, or 1.4-5.0 wt %, or 1.5-5.0 wt %, or 1.6-5.0 wt %, or 1.8-5.0 wt %, or 2.0-5.0 wt %, or 2.2-5.0 wt %.
   Embodiment 15. The waxy tapioca starch according to any of embodiments 1-9, wherein the starch has a degree of octenylsuccinylation in the range of 1.0-4.0 wt %, e.g., 1.2-4.0 wt %, or 1.3-4.0 wt %, or 1.4-4.0 wt %, or 1.5-4.0 wt %, or 1.6-4.0 wt %, or 1.8-4.0 wt %, or 2.0-4.0 wt %, or 2.2-4.0 wt %.
   Embodiment 16. The waxy tapioca starch according to any of embodiments 1-9, wherein the starch has a degree of octenylsuccinylation in the range of 1.0-3.0 wt %, e.g., 1.2-3.0 wt %, or 1.3-3.0 wt %, or 1.4-3.0 wt %, or 1.5-3.0 wt %, or 1.6-3.0 wt %, or 1.8-3.0 wt %, or 2.0-3.0 wt %, or 2.2-3.0 wt %.
   Embodiment 17. The waxy tapioca starch according to any of embodiments 1-9, wherein the starch has a degree of octenylsuccinylation in the range of 1.0-2.8 wt %, e.g., 1.2-2.8 wt %, or 1.3-2.8 wt %, or 1.4-2.8 wt %, or 1.5-2.8 wt %, or 1.6-2.8 wt %, or 1.8-2.8 wt %, or 2.0-2.8 wt %, or 2.2-2.8 wt %.
   Embodiment 18. The waxy tapioca starch according to any of embodiments 1-9, wherein the starch has a degree of octenylsuccinylation in the range of 1.0-2.5 wt %, e.g., 1.2-2.5 wt %, or 1.3-2.5 wt %, or 1.4-2.5 wt %, or 1.5-2.5 wt %, or 1.6-2.5 wt %, or 1.8-2.5 wt %, or 2.0-2.5 wt %.
   Embodiment 19. The waxy tapioca starch according to any of embodiments 1-9, wherein the starch has a degree of octenylsuccinylation in the range of 1.0-2.2 wt %, e.g., 1.2-2.2 wt %, or 1.3-2.2 wt %, or 1.4-2.2 wt %, or 1.5-2.2 wt %, or 1.6-2.2 wt %, or 1.8-2.2 wt %.
   Embodiment 20. The waxy tapioca starch according to any of embodiments 1-9, wherein the starch has a degree of octenylsuccinylation of not more than 2.8 wt %. e.g., no more than 2.5 wt %, or no more than 2.2 wt %.
   Embodiment 21. The waxy tapioca starch according to any of embodiments 1-20, wherein the starch is unthinned.
   Embodiment 22. The waxy tapioca starch according to any of embodiments 1-20, wherein the starch is thinned.
   Embodiment 23. The waxy tapioca starch according to embodiment 22, wherein the starch is acid-thinned, enzyme-thinned, and/or shear-thinned.
   Embodiment 24. The waxy tapioca starch according to embodiment 22, wherein the starch is acid-thinned.
   Embodiment 25. The waxy tapioca starch according to embodiment 24, wherein the starch is not enzyme thinned.
   Embodiment 26. The waxy tapioca starch according to any of embodiments 1-25, having a Water Fluidity up to 70 mL, e.g., up to 60 mL, or up to 50 mL.
   Embodiment 27. The waxy tapioca starch according to any of embodiments 1-25, having a Water Fluidity in the range of 10-70 mL, e.g., 10-60 mL, or 10-50 mL, or 20-70 mL, or 20-60 mL, or 20-50 mL, or 30-70 mL, or 30-60 mL, or 30-50 mL
   Embodiment 28. The waxy tapioca starch according to any of embodiments 1-25, having a Water Fluidity of at least 60 mL, e.g., at least 70 mL, or at least 80 mL, or at least 90 mL.
   Embodiment 29. The waxy tapioca starch according to any of embodiments 1-25, having a Water Fluidity in the range of 60-95 mL, e.g., 60-90 mL, or 60-80 mL, or 70-95 mL, or 70-90 mL, or 70-80 mL, or 80-95 mL, or 80-90 mL, or 90-95 mL.
   Embodiment 30. The waxy tapioca starch according to any of embodiments 1-29, having a viscosity in the range of 5-2000 cP in an RVA test at 5% solids.
   Embodiment 31. The waxy tapioca starch according to any of embodiments 1-29, having a viscosity in the range of 300-2000 cP, or 300-1800 cP, or 300-1600 cP, or 500-2000 cP, or 500-1800 cP, or 500-1600 cP, or 500-1400 cP, or 500-1200 cP, or 800-2000 cP, or 800-1800 cP, or 800-1600 cP, or 800-1400 cP, or 800-1200 cP, in an RVA test at 5% solids.
   Embodiment 32. The waxy tapioca starch according to any of embodiments 1-29, a viscosity in the range of 5-800 cP, or 5-600 cP, or 5-400 cP, or 5-200 cP, or 100-1000 cP, or 100-800 cP, or 100-600 cP, or 100-400 cP, or 300-1000 cP, or 300-800 cP, or 300-600 cP, or 500-1000 cP, or 500-800 cP in an RVA test at 5% solids.
   Embodiment 33. The waxy tapioca starch according to any of embodiments 1-29, a viscosity in the range of 100-1000 cP at 20% solids.
   Embodiments 34. The waxy tapioca starch according to any of embodiments 1-29, a viscosity in the range of 100-1200 cP at 45% solids.
   Embodiment 35. The waxy tapioca starch according to any of embodiments 1-34, does not have a measured sedimentation volume in the range of 1-70 mL/g.
   Embodiment 36. The waxy tapioca starch according to any of embodiments 1-35, wherein the waxy tapioca starch is not hydroxypropylated.
   Embodiment 37. The waxy tapioca starch according to any of embodiments 1-36, wherein the waxy tapioca starch is not acetylated.
   Embodiment 38. The waxy tapioca starch according to any of embodiments 1-37, wherein the waxy tapioca starch is not carboxymethylated.
   Embodiment 39. The waxy tapioca starch according to any of embodiments 1-38, wherein the waxy tapioca starch is not hydroxyethylated.
   Embodiment 40. The waxy tapioca starch according to any of embodiments 1-39, wherein the waxy tapioca starch is not phosphated.
   Embodiment 41. The waxy tapioca starch according to any of embodiments 1-40, wherein the waxy tapioca starch is not cationic or zwitterionic.
   Embodiment 42. An octenylsuccinylated waxy tapioca starch made by the process comprising:
providing a waxy tapioca slurry at a basic pH;
adding octenylsuccinic anhydride to the slurry;
maintaining the basic pH of the slurry; and
   mixing the slurry for a time sufficient to provide an octenylsuccinylated waxy tapioca starch.
      Embodiment 43. A method for producing an octenylsuccinylated waxy tapioca starch comprising:
providing a waxy tapioca slurry at a basic pH;
adding octenylsuccinic anhydride to the slurry;
maintaining the basic pH of the slurry; and
mixing the slurry for a time sufficient to provide an octenylsuccinylated waxy tapioca starch.
   Embodiment 44. A waxy tapioca starch of any of embodiments 1-41 made by the method of embodiment 43.
   Embodiment 45. An emulsion comprising an emulsified phase that is a hydrophobic phase emulsified with an aqueous phase, stabilized by a gelatinized starch that is the gelatinized product of a waxy tapioca starch having
an amylopectin content in the range of 90-100%; and
a degree of octenylsuccinylation in an amount of at least 1.0 wt % on a dry solids basis,
   wherein
the starch is not inhibited.
   Embodiment 46. An emulsion according to embodiment 45, wherein the gelatinized starch has the characteristics described for the pregelatinized starches of any of embodiments 1-42.
   Embodiment 47. A method for making an emulsion (e.g., an emulsion according to embodiment 45 or embodiment 46), comprising mixing a hydrophobic phase, an aqueous phase and a waxy tapioca starch according to any of embodiments 1-42 under conditions sufficient to form the emulsion (e.g., under shear).
   Embodiment 48. A method according to embodiment 47, further comprising gelatinizing the waxy tapioca starch.
   Embodiment 49. The emulsion or method of any of embodiments 45-48, wherein the waxy tapioca starch is present in the emulsion in an amount in the range of at least 1 wt % of the hydrophobic phase, e.g., at least 2 wt %, at least 5 wt %, or at least 10 wt %.
   Embodiment 50 The emulsion or method of any of embodiments 45-48, wherein the amount of the waxy tapioca starch in the emulsion is in the range of 1-200 wt %, e.g., 2-200 wt %, or 5-200 wt %, or 10-200 wt %, or 1-100 wt %, or 2-100 wt %, or 5-100 wt %, or 10-100 wt %, or 1-50 wt %, or 2-50 wt %, or 5-50 wt %, or 10-50 wt %, or 1-25 wt %, or 2-25 wt %, or 5-25 wt %, or 10-25 wt % of the hydrophobic phase.
   Embodiment 51. The emulsion or method of any of embodiments 45-50, wherein the emulsion has a median emulsion droplet size (i.e., of the emulsified phase) in the range of 0.2-100 microns, e.g., 0.2-75 microns, or 0.2-50 microns, or 0.2-25 microns, or 0.2-15 microns, or 0.2-5 microns, or 0.5-100 microns, or 0.5-50 microns, or 0.5-25 microns, or 0.5-15 microns, or 0.5-5 microns.
   Embodiment 52. The emulsion or method of any of embodiments 45-51, wherein the aqueous phase is present in the emulsion in an amount in the range of at least 30 wt %, e.g., at least 35 wt %, or at least 40%, or at least 45%, or at least 50 wt %, or at least 60 wt %, or at least 65 wt %, or at least 70 wt %, or at least 75 wt %, or at least 80 wt %, or at least 85 wt %.
   Embodiment 53. The emulsion or method of any of embodiments 45-52, wherein the hydrophobic phase is present in the emulsion in an amount in the range of 0.5-70 wt %, e.g., 0.5-50 wt %, or 0.5-35 wt %, or 0.5-15 wt %.
   Embodiment 54. A food or beverage product comprising an emulsion according to any of embodiments 45, 46 or 49-53.
   Embodiment 55. A food or beverage product according to embodiment 54, wherein the food product is a gravy, a sauce (e.g., a mayonnaise, a white sauce or a cheese sauce), a soup, or a stew.
   Embodiment 56. A food or beverage product according to embodiment 54, wherein the food or beverage product is a dressing such as a salad dressing (e.g., pourable or spoonable)
   Embodiment 57. A food or beverage product according to embodiment 54, wherein the food or beverage product is a dairy product, e.g. a yogurt, a sour cream, an ice cream or an ice milk.
   Embodiment 58. A food or beverage product according to embodiment 54, wherein the food or beverage product is a dairy substitute, e.g., a non-dairy creamer, a plant milk (such as an oat milk, a soy milk or a nut milk) or a food or beverage based thereon (e.g., an ice cream analog based on such milks), or a margarine.
   Embodiment 59. A food or beverage product according to embodiment 54, wherein the food or beverage product is a cream filling or a custard.
   Embodiment 60. A food or beverage product according to embodiment 54, wherein the food or beverage product is a confectionary, e.g., a chocolate.
   Embodiment 61. A food or beverage product according to embodiment 54, wherein the food or beverage product is a mousse.
   Embodiment 62. A food or beverage product according to embodiment 54, wherein the food or beverage product is a smoothie or a shake.
   Embodiment 63. A personal care composition or nutraceutical composition or pharmaceutical composition comprising an emulsion according to any of embodiments 45, 46 or 49-53.

While various embodiments and aspects of the present invention are shown and described herein, it will be evident to those skilled in the art that such embodiments and aspects are provided by way of example only. Numerous variations, changes, and substitutions will now occur to those skilled in the art without departing from the disclosure. It should be understood that various alternatives to the embodiments of the disclosure specifically described herein may be employed in practicing the compositions and methods of the disclosure.

1-25. (canceled)

26. An emulsion comprising an emulsified phase that is a hydrophobic phase emulsified with an aqueous phase, stabilized by a gelatinized starch that is the gelatinized product of a waxy tapioca starch having
an amylopectin content in the range of 90-100 wt % and
a degree of octenylsuccinylation of at least 1.0 wt % on a dry solids basis,
wherein
the starch is not inhibited.

27. The emulsion according to claim 26, wherein the waxy tapioca starch has an amylopectin content of at least 99%.

28. The emulsion according to claim 26, wherein the starch has a degree of octenylsuccinylation of at least 1.6 wt %.

29. The emulsion according to claim 26, wherein the starch has a degree of octenylsuccinylation in the range of 1.0-5.0 wt %.

30. The emulsion according to claim 26, wherein the starch has a degree of octenylsuccinylation in the range of 1.0-3.0 wt %.

31. The emulsion according to claim 26, wherein the starch has a Water Fluidity up to 70 mL.

32. The emulsion according to claim 26, wherein the starch has a Water Fluidity of at least 60 mL.

33. The emulsion according to claim 26, wherein the starch is unthinned.

34. The emulsion according to claim 26, wherein the starch is thinned.

35. The emulsion according to claim 26, wherein the starch does not have a measured sedimentation volume in the range of 1-70 mL/g.

36. The emulsion according to claim 26, wherein the waxy tapioca starch is not hydroxypropylated, is not acetylated, is not carboxymethylated, is not hydroxyethylated, is not phosphated and is not cationic or zwitterionic.

37. The emulsion according to claim 26, wherein the waxy tapioca starch is present in the emulsion in an amount in the range of at least 1 wt % of the hydrophobic phase.

38. The emulsion according to claim 26, wherein the emulsion has a median emulsion droplet size in the range of 0.2-100 microns.

39. The emulsion according to claim 26, wherein the aqueous phase is present in the emulsion in an amount in the range of at least 30 wt %, and wherein the hydrophobic phase is present in the emulsion in an amount in the range of 0.5-70 wt %.

40. A method for making an emulsion according to claim 26, comprising mixing a hydrophobic phase, an aqueous phase and the waxy tapioca starch under conditions sufficient to form the emulsion.

41. A method according to claim 40, wherein the mixing comprises gelatinizing the waxy tapioca starch.

42. A food or beverage product comprising an emulsion according to claim 26.

43. A method for producing an octenylsuccinylated waxy tapioca starch comprising:
providing a waxy tapioca slurry at a basic pH;
adding octenylsuccinic anhydride to the slurry;
maintaining the basic pH of the slurry; and
mixing the slurry for a time sufficient to provide an octenylsuccinylated waxy tapioca starch.

44. A waxy tapioca starch made by the method of claim 43.

45. A waxy tapioca starch having
an amylopectin content in the range of 90-100%; and
a degree of octenylsuccinylation of at least 1.0 wt % on a dry solids basis,
wherein
the starch is not inhibited, and
the starch is optionally pregolatinized.
